(19) United States
(12) Patent Application Publication
(10) Pub. No.: US 2010/0124290 A1
(43) Pub. Date: May 20, 2010

(54) Digital Signal Transmission for Wireless Communication

(76) Inventor: Joshua A. Kablotsky, Carlisle, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/273,606

(22) Filed: Nov. 19, 2008

(51) Int. Cl. H04L 27/00

(52) U.S. Cl. 375/259; 375/295

(57) ABSTRACT

A signal is digitally processed for transmission based on a digital baseband input signal. The digital signal is modulated to generate a digital pulse signal at a sample frequency, and an RF transmit signal is generated at a transmit frequency responsive to the pulse signal, where the sample frequency is a multiple of the transmit frequency. In various embodiments, a digital transmitter implementing the invention includes a baseband modem, a modulator, and an amplifier. The modem operates on a digital input signal at a baseband frequency and generates a processed signal which is modulated by the modulator, such as a sigma-delta modulator, to generate a digital pulse signal at a sample frequency. The digital pulse signal drives the amplifier which produces a RF transmit signal at a transmit frequency for transmission using an antenna.

### FIELD OF THE INVENTION

The present invention relates to a digital transmitter for a communication device.

### BACKGROUND

Modern wireless communications systems, such as cellular telephone systems, employ digital modulation technologies such as time-division multiple access (TDMA), code-division multiple access (CDMA) technologies including conventional CDMA, wideband CDMA (WCDMA), and CDMA2000 standards, orthogonal frequency-division multiplexing (OFDM) and personal communications service (PCS) modulation. These modulation techniques operate at carrier frequencies ranging from about 800 MHz to as high as 3.5 GHz. These and other digital modulation and communication techniques have greatly improved wireless telephone services. However, the transmit section of such communication systems still includes analog components to generate the RF signal sent over the wireless channel, and such components may suffer from poor system efficiency.

FIG. 1 illustrates a transmit section of a conventional wireless communication system, which includes a baseband modem 12, a pair of digital to analog converters (DACs) 14, a synthesizer 16 which generates signals of fixed frequencies, an analog mixer 18, an output amplifier 20, and an antenna 22. The baseband modem 12 takes a digital input signal, such as a TDMA signal, in and modulates it to output in-phase and quadrature-phase (I/Q) digital signals. The digital I/Q signals are converted to the analog domain using DACs 14, and the resulting analog signals are applied to the mixer 18. The synthesizer 16 generates signals of fixed (or programmable) high frequencies, which are mixed (through multiplication) with the I/Q signals to create a “mixed” high-frequency signal to drive the output amplifier 20. The output amplifier 20, in turn, boosts the signal for transmission through the antenna 22. The output amplifier 20 usually includes a variable-gain amplifier and a power amplifier.

Typically, power amplifiers used in such systems are feed-forward class AB amplifiers, the efficiency of which may depend on the modulation scheme used for the signal transmission. For example, the use of OFDM as the modulation technique tends to increase the peak-to-average signal ratio, due to which the power amplifiers suffer from a low efficiency of around 20%. The use of such power amplifiers and other analog components reduces the overall efficiency of the transmit signal chain (from modem to antenna). There is, accordingly, a need for more efficient transmission in wireless communication systems.

### SUMMARY

In accordance with embodiments of the present invention, the problem of low efficiency is addressed by altering the entire transmit signal chain of a communication system to include digital components, and leveraging the existence of digital I/Q signals within the system by providing these signals directly to the digital components (i.e., without any digital-to-analog conversion).

In broad overview, transmitters and methods in accordance with the invention may be implemented in connection with wireless communication devices, e.g., base station transmitters of a cellular network. In one embodiment of the invention, the digital input signal at a baseband frequency is processed, e.g., into an in-phase (I) and a quadrature-phase (Q) digital signal also at the baseband frequency. The processed signal is modulated, e.g., using digital sigma-delta modulation, into a digital pulse signal at a sample frequency. The digital pulse signal is used to drive an amplifier at the output stage of the transmitter to generate a RF transmit signal at a transmit, or carrier frequency. The sample frequency may be a multiple of the carrier frequency. In one embodiment, jitter in the pulse signal at the sample frequency may be removed before feeding it to the amplifier. Quantization noise in the RF transmit signal may be reduced, e.g., by using noise-shaping techniques, before transmitting the signal over a communication signal.

Accordingly, in one aspect, the invention comprises a digital transmitter for a communication device. The transmitter includes a baseband modem, a modulation stage and an amplifier. The baseband modem digitally process the digital input signal, and the processed signal may include an in-phase (I) and a quadrature-phase (Q) signal. The modulation stage modulates the processed signal and generates a first digital pulse signal at a sample frequency. In various embodiments, the modulation stage may be or may comprise of a sigma-delta modulator, or a pulse width modulator. The use of such modulators results in a broader bandwidth for transmission. The first pulse signal from the modulation stage may be characterized by at least two amplitude levels, e.g., a binary signal. The amplifier is fed the digital pulse signal to generate a RF transmit signal at a transmit frequency. The amplifier may be a high slew-rate amplifier. In one embodiment, the sample frequency is a multiple of the transmit frequency.

In one embodiment, the transmitter further comprises a clock and recovery module to remove jitter from the first digital pulse signal produced by the modulation stage and the amplifier is fed the jitter-free pulse signal. The transmitter may further comprise a RF band-pass filter, having an input coupled to the amplifier, for reducing noise from the RF transmit signal. The band-pass filter may be, for example, a Butterworth bandpass LC filter or a Chebyshev bandpass LC filter.

In one embodiment, the modulation stage includes a first and a second upsampler to upconvert the digital I and Q signals to the sample frequency; a first and a second mixer for multiplying the upconverted I and Q signals with sinusoids, which may be orthogonal; an adder to combine the multiplied I and Q signals; and a modulator to use the combined signal to generate the first digital pulse signal. In various embodiments, the modulator is a sigma-delta modulator.

In another embodiment, the modulation stage includes a first and a second modulator to modulate the I and the Q signal from the baseband modem and generate I and Q digital pulses; a first and a second mixer to multiply the I and Q digital pulses with sinusoids, which may be orthogonal; and an adder to combine the multiplied I and Q pulse signals and generate the first pulse signal. In various embodiments, at least one of the first and second modulators is sigma-delta modulator.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 depicts a block diagram of an analog transmit section of a conventional wireless communication system;

FIG. 2 depicts a block diagram of a digital transmitter according to an illustrative embodiment of the invention;

FIG. 3 depicts a block diagram of sigma-delta modulator utilized in various embodiments of the transmitter depicted in FIG. 2;

FIG. 4 depicts a block diagram of a modulation stage of the transmitter depicted in FIG. 2 according to a first embodiment of the invention; and

FIG. 5 depicts a block diagram of a modulation stage of the transmitter depicted in FIG. 2 according to a second embodiment of the invention.

### DESCRIPTION OF THE INVENTION

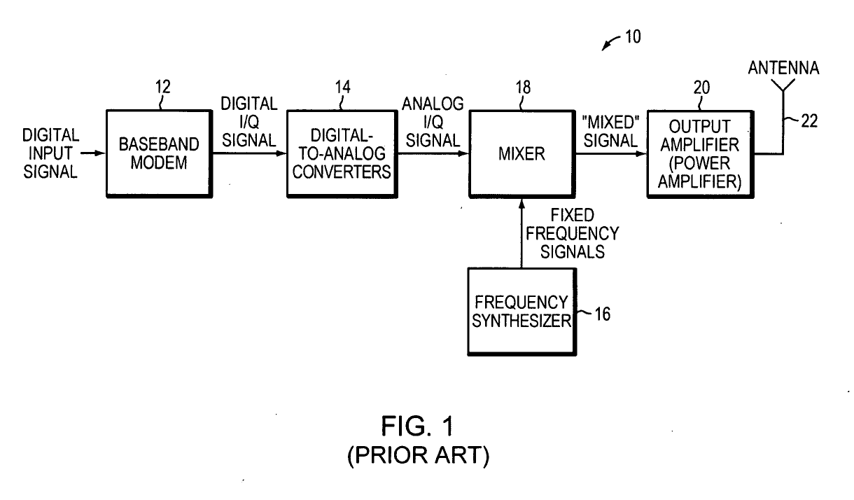

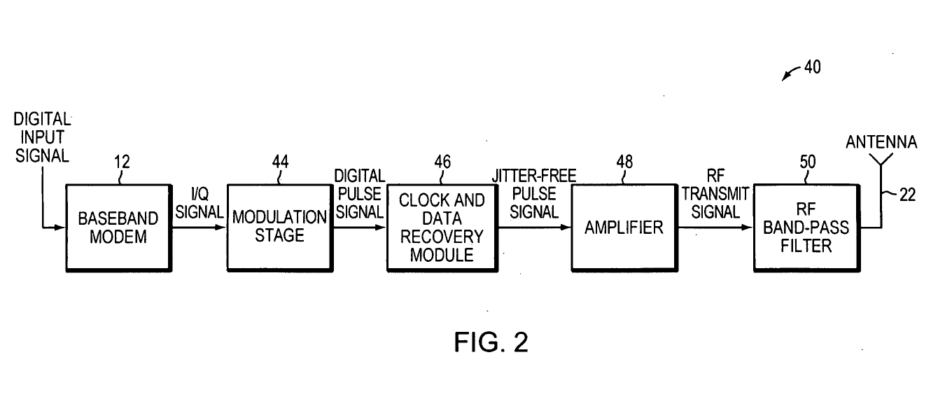

Refer first to FIG. 2, which depicts a digital transmitter 40 according to an illustrative embodiment of the invention. The illustrated transmitter 40 includes the baseband modem 12 as in the conventional communication system depicted in FIG. 1, a modulation stage 44, a clock and data recovery module 46, an amplifier 48, an RF band-pass filter 50, and the antenna 22. The operation and construction of these components according to various embodiments of the invention will be described in detail below.

The digital transmitter 40 may be realized in a discrete device, based, for example, on complementary metal-oxide-semiconductor (CMOS) technology. In one embodiment, the transmitter 40 is realized fully digitally in the same integrated circuit as other components (not shown in FIG. 2) of, for example, a digital baseband processor at the transmit side of a communication system. This may result in performance improvements and reduced costs. Conventional transmitters, such as that depicted in FIG. 1, typically requires bipolar, BiCMOS, or GaAs technology, and as such cannot be readily scaled along with conventional digital baseband processors.

In one embodiment, the baseband modem 12 (a conventional component) takes as input a digital signal at a baseband frequency, e.g., in the form of a single-bit bitstream, and processes it to generate a processed signal at the baseband frequency including an in-phase digital signal and a quadrature-phase signal. The processing at the baseband modem 12 may include serial-to-parallel conversion in which the serial input bitstream is grouped into successive words, and the parallel words are assigned to the in-phase and quadrature-phase signals. The particular manner in which the bitstream is split to form the words and, hence, to generate these orthogonal components is not critical, so long as a receiver can reassemble the components back into intelligible information in the form of a digital baseband bitstream. The width of the parallel data words output by the baseband modem 12 may depend, for example, on the transmit frequency of a communication system. For example, in CDMA communications, serial-to-parallel conversion in the baseband modem 12 outputs data words ranging from six to eight bits in width, at a frequency of 4.8 MHz, for each of the in-phase and quadrature-phase signals; in WCDMA communications, the baseband modem 12 may generate six- to eight-bit-wide data words at a frequency of 3.84 MHz.

The in-phase and quadrature-phase signals at the baseband frequency are applied to the input of the modulation stage 44, which modulates the signals and generates a digital pulse signal at a sample frequency. The modulation stage may be or may comprise a sigma-delta modulator, or a pulse-width modulator. In one embodiment, in the case of a sigma-delta modulator, the sample frequency is a multiple of (e.g., four times) a transmit carrier frequency of the transmitter 40.

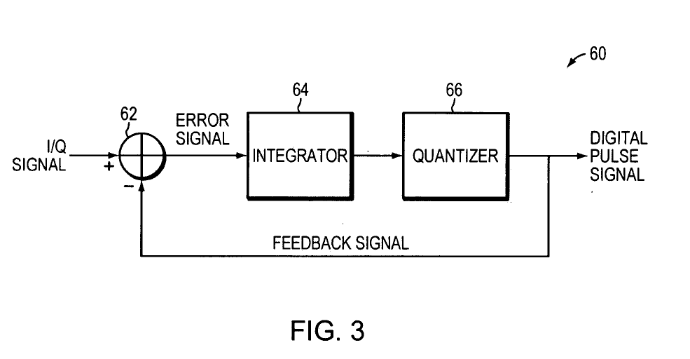

FIG. 3 illustrates the detailed construction of a suitable digital sigma-delta modulator 60 for use in connection with various embodiments of the transmitter 40. The depicted sigma-delta modulator 60 comprises an adder 62, an integrator 64, and a quantizer 66. The integrator 64 may be a first-order integrator or may be a higher-order integrator, which determines whether the sigma-delta modulator 60 is a first-order or a higher-order modulator. The I/Q signals from the baseband modem 12 are applied to the adder 62, the other input of which is fed by a feedback signal. As depicted in FIG. 3, the adder 62 subtracts the output of the quantizer 66 from the input signal. Therefore, the output of the adder 62 may be an error signal which is fed to the integrator 64. The integrator 64, in turn, integrates the error signal and feeds it to the quantizer 66, which quantizes the integrated error signal. The quantization step may comprise comparison of the integrated error signal with a threshold so as to produce a digital pulse signal at a sample frequency. The digital pulse signal produced by quantization may be characterized by two (in the case of a binary signal) or more amplitude levels. In one embodiment, the sample frequency is centered at the transmit frequency, and is a multiple of (e.g., four times) a transmit carrier frequency. The sigma-delta modulator 60 may be constructed to have attenuation in the noise transfer function about the carrier frequency. Accordingly, the resulting digital pulse signal may have a minimal in-band noise energy. The sigma-delta modulator 60 may be a low-pass modulator, a band-pass modulator, or a high-pass modulator. As described above, the sigma-delta modulator 60 effectively corresponds to digital signal processing operations, and as such may be realized by way of logic hardware or alternatively by way of a program sequence executed by a digital signal processor (DSP).

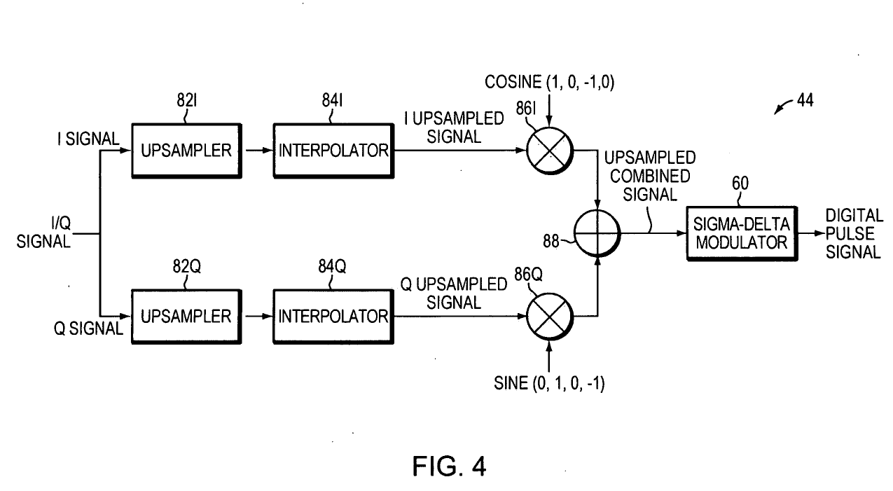

FIG. 4 shows the detailed construction of an embodiment of the modulation stage 44. In this embodiment, the digital I and Q signals from the baseband modem 12 are applied to an upsampler 82I and an upsampler 82Q, respectively. The upsamplers 82I, 82Q may be identical in construction. As mentioned earlier, the sample frequency of the pulse signal may be four times the transmit frequency. Accordingly, the upsamplers 82I and 82Q upconvert the baseband frequency of the in-phase and quadrature-phase signals to the sample frequency. In one embodiment, each of the upsamplers 82I, 82Q is implemented using a multi-stage filter. In such implementations, zeros are first inserted between the original samples of the signal according to a given upsampling factor, and then the zero-inserted signal is filtered through a low-pass filter. This low-pass filter may be realized as a multi-stage filter by decomposing the impulse response sequence of the low-pass filter into several subsequences, each of which is implemented as a sub-filter having a shorter filter length (and therefore better computational efficiency) as compared to that of the low-pass filter. In another embodiment, the upsamplers 82I, 82Q are implemented as circuits that buffer an incoming signal at one rate to an output signal at another rate. In yet another embodiment, the upsamplers 82I, 82Q output the signal at a higher frequency by simply repeating each sample of the incoming I or Q signal according to a desired sample frequency.

Following the application of upsamplers 82I, 82Q, the upconverted I and Q signals may be applied to a pair of interpolators 84I, 84Q. The interpolators 84I, 84Q may be implemented as low-pas filters, which perform interpolation of the zero-valued samples obtained after upconversion using non-zero original samples of the respective I and Q signals.

As shown in FIG. 4, a digital mixer 86I multiplies the upconverted in-phase signal with a first sinusoid at the transmit frequency, e.g., a digital cosine signal, and a digital mixer 86Q multiplies the upconverted quadrature-phase signal with a second sinusoid at the transmit frequency, e.g., a digital sine signal. The digital mixers 86I, 86Q may be implemented as digital multipliers (e.g., binary shifters, which are conventional in the art) to achieve both accuracy and efficient performance. Alternatively, the digital mixers 86I, 86Q may be realized as multiplexer circuits, in which case the incoming I or Q signal from the corresponding interpolator is applied to one multiplexer input and, using an inverter circuit, an inverted I or Q signal (i.e., −I or −Q) is applied to a second input of multiplexer. A third multiplexer input receives a zero data value (a “0” binary level for each of a number of bits of the incoming I and Q signal). Control bits may be applied to the multiplexer to cause the multiplexer to select among its inputs. For example, control bits applied to multiplexers serving as the mixers 86I, 86Q may be in a pattern corresponding to a cosine signal (1, 0, −1, 0) or a sine signal (0, 1, 0, −1). Accordingly, at the output of one of the multiplexers, the signal (1, 0, −I, 0) results from multiplication of the I signal with the cosine signal, and at the output of the other multiplexer, the signal (0, Q, 0, −Q) is obtained by multiplication of the Q signal with the sine signal.

The upconverted and multiplied I and Q signals are combined at the adder 88. As is evident from the above description, the I signal obtained from the mixer 86I and the Q signal obtained from the mixer 86Q are orthogonal and, accordingly, do not simultaneously present non-zero values. Accordingly, the adder 88 may be a digital adder, or alternatively may be a multiplexer with a select input signal that is synchronized with the in-phase and the quadrature signals. The combined signal generated by the adder 88 is then presented to the digital sigma-delta modulator 60, for modulation into a digital pulse signal which drives the output stage—i.e., the amplifier 48 depicted in FIG. 2—of a transmitter 40.

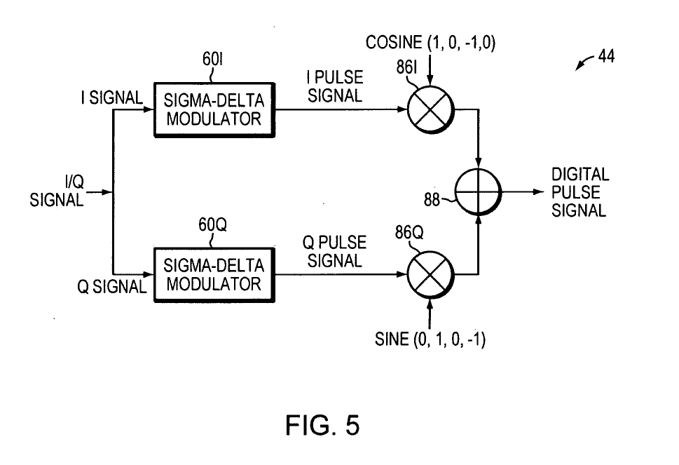

FIG. 5 illustrates the detailed construction of a second embodiment of the modulation stage 44. This second embodiment differs from the first embodiment of FIG. 4, in that the individual modulations are carried out for I and Q signals using individual sigma-delta modulators. In this second embodiment, the I and Q signals from the modem 12 are directly applied to independent sigma-delta modulators 60I, 60Q. Sigma-delta modulators 60I, 60Q generate digital pulse signals, i.e., an I pulse signal and a Q pulse signal, corresponding to the I and Q signals. These pulse signals are accordingly applied to the mixers 86I, 86Q for multiplication of the I and Q pulse signals with a cosine and a sine signal, respectively. The multiplied I and Q pulse signals are combined at the adder 88 to generate a combined pulse signal which drives the output stage of the transmitter 40.

With renewed reference to FIG. 2, the digital pulse signal generated by the modulation stage 44 at the sample frequency may suffer from jitter, i.e., deviation from an ideal phase of the signal. In one embodiment, jitter is removed with the clock and data recovery module 46, which may be implemented using a phase-locked loop (PLL). The input of the PLL circuit is the phase of a reference signal (a clock or a serial data signal) with which the input pulse signal is contrasted in a phase comparator, and an error signal is generated. The error signal is low-pass filtered and used to drive a voltage-controlled oscillator (VCO), which creates an output frequency. The output frequency is fed through a frequency divider back to the input of the system, producing a negative feedback loop. If the output frequency drifts, the error signal will increase, driving the frequency of the VCO in the opposite direction so as to reduce the error. Accordingly, the output is locked to the frequency of the reference signal and a jitter-free digital pulse signal is recovered.

The jitter-free pulse signal is applied to and drives the amplifier 48, which generates the RF transmit signal at the transmit frequency. The amplifier 48 may be a high slew-rate amplifier, a field-effect transistor (FET) amplifier, or a combination of both.

The RF transmit signal generated by the amplifier 48 may include quantization noise carried over from the sigma-delta modulator 60. To reduce this noise, the RF signal is fed to the RF band-pass filter 50. The RF band-pass filter 50 may be implemented as a Butterworth or a Chebyshev bandpass LC filter which operates within the transmit frequency and rejects other frequency bands, such as high frequencies (where quantization noise typically resides in a low-pass sigma-delta modulated signal), the receive frequency band, and frequency bands of other services, e.g., GPS. Accordingly, the band-pass filter 50 may have notches or zeroes in the characteristic that preferably align with the frequencies of quantization noise and those of the other bands from which interference is to be minimized

The noise-free RF signal is then transmitted is fed to the antenna 22 for transmission over a communication channel.

The invention can be embodied in other specific forms without departing from the spirit or essential characteristics thereof. The foregoing embodiments are therefore to be considered in all respects illustrative rather than limiting on the invention described herein.

What is claimed is:

1. A digital transmitter, comprising:
a baseband modem for processing a digital baseband input signal at a baseband frequency wherein the processed signal comprises an in-phase digital signal and a quadrature-phase digital signal;
a modulation stage for modulating the processed signal and generating a first digital pulse signal at a sample frequency, the modulation stage comprising:
a first upsampler for upsampling the in-phase signal to the sample frequency;
a second upsampler for upsampling the quadrature-phase signal to the sample frequency;
a first mixer, coupled to the first upsampler, for multiplying the upsampled in-phase signal with a first sinusoid;
a second mixer, coupled to the second upsampler, for multiplying the upsampled quadrature-phase signal with a second sinusoid;
an adder for combining the multiplied in-phase and quadrature-phase signals; and
a modulator for modulating the combined in-phase and quadrature-phase signals and generating the first digital pulse signal; and
an amplifier for generating an RF transmit signal at a transmit frequency responsive to the first pulse signal, wherein the sample frequency is a multiple of the transmit frequency.

2. The transmitter of claim 1 further comprising a recovery module, coupled to the modulation stage, for removing jitter from the first pulse signal prior to amplification thereof.

3. The transmitter of claim 1 further comprising a RF band-pass filter, coupled to the amplifier, for reducing noise from the RF transmit signal.

4. The transmitter of claim 1, wherein the amplifier is a high slew-rate amplifier.

5. The transmitter of claim 1, wherein the modulator is a sigma-delta modulator.

6. The transmitter of claim 1, wherein the first pulse signal is characterized by at least two amplitude levels.

7. The transmitter of claim 1, wherein at least one of the first upsampler and the second upsampler is a multi-stage filter.

8. The transmitter of claim 3, wherein the band-pass filter is a Butterworth band-pass LC filter or a Chebyshev band-pass LC filter.

9. A digital transmitter, comprising:
a baseband modem for processing a digital baseband input signal at a baseband frequency wherein the processed signal comprises an in-phase digital signal and a quadrature-phase digital signal;
a modulation stage for modulating the processed signal and generating a first digital pulse signal at a sample frequency, the modulation stage comprising:
a first modulator for modulating the in-phase signal and generating a second digital pulse signal;
a second modulator for modulating the quadrature-phase signal and generating a third digital pulse signal;
a first mixer, coupled to the first modulator, for multiplying the second pulse signal with a first sinusoid;
a second mixer, coupled to the second modulator, for multiplying the third pulse signal with a second sinusoid; and
an adder for combining the second multiplied pulse signal and the third multiplied pulse signal to generate the first pulse signal; and
an amplifier for generating an RF transmit signal at a transmit frequency responsive to the first pulse signal, wherein the sample frequency is a multiple of the transmit frequency.

10. The transmitter of claim 9 further comprising a recovery module, coupled to the modulation stage, for removing jitter from the first pulse signal prior to amplification thereof.

11. The transmitter of claim 9 further comprising a RF band-pass filter, coupled to the amplifier, for reducing noise from the RF transmit signal.

12. The transmitter of claim 9, wherein the amplifier is a high slew-rate amplifier.

13. The transmitter of claim 9, wherein at least one of the first modulator and the second modulator is a sigma-delta modulator.

14. The transmitter of claim 9, wherein the first pulse signal is characterized by at least two amplitude levels.

15. The transmitter of claim 11, wherein the band-pass filter is a Butterworth band-pass LC filter or a Chebyshev band-pass LC filter.

16. A method of digitally processing a signal in a transmitter, the method comprising:
processing a digital baseband input signal comprising an in-phase digital signal and a quadrature-phase digital signal;
modulating the processed digital signal to generate a first digital pulse signal at a sample frequency, the modulating step comprising:
upsampling the in-phase signal to the sample frequency;
upsampling the quadrature-phase signal to the sample frequency;
multiplying the upsampled in-phase signal with a first sinusoid;
multiplying the upsampled quadrature-phase signal with a second sinusoid;
combining the multiplied in-phase and quadrature-phase signals; and
modulating the combined in-phase and quadrature-phase signals to generate the first digital pulse signal; and
generating an RF transmit signal at a transmit frequency responsive to the first pulse signal, wherein the sample frequency is a multiple of the transmit frequency.

17. The method of claim 16 further comprising removing jitter from the first pulse signal prior to generating the RF signal.

18. The method of claim 16 further comprising reducing noise from the RF transmit signal.

19. The method of claim 16, wherein the step of modulating the combined in-phase and quadrature-phase signals is performed by a sigma-delta modulator.

20. The method of claim 16, wherein at least one of the upsampling steps utilizes a multi-stage filter for upsampling.

21. A method of digitally processing a signal in a transmitter, the method comprising:
processing a digital baseband input signal comprising an in-phase digital signal and a quadrature-phase digital signal;
modulating the processed digital signal to generate a first digital pulse signal at a sample frequency, the modulating step comprising:
modulating the in-phase signal and generating a second digital pulse signal;
modulating the quadrature-phase signal and generating a third digital pulse signal;
multiplying the second pulse signal with a first sinusoid;
multiplying the third pulse signal with a second sinusoid; and
combining the second multiplied pulse signal and the third multiplied pulse signal to generate the first pulse signal; and
generating an RF transmit signal at a transmit frequency responsive to the first pulse signal, wherein the sample frequency is a multiple of the transmit frequency.

22. The method of claim 21, wherein at least one of the steps of modulating the in-phase signal and modulating the quadrature-phase signal is performed by a sigma-delta modulator.
